(19) United States
(12) Patent Application Publication
(10) Pub. No.: US 2019/0241160 A1
(43) Pub. Date: Aug. 8, 2019

(54) E-Z TRAM

(71) Applicant: David Grawe, Coal Valley, IL (US)

(72) Inventor: David Grawe, Coal Valley, IL (US)

(21) Appl. No.: 16/265,954

(22) Filed: Feb. 1, 2019

Related U.S. Application Data
(60) Provisional application No. 62/627,176, filed on Feb. 6, 2018.

(51) Int. Cl. B60S 5/00; G01B 5/00

(52) U.S. Cl. CPC B60S 5/00; G01B 5/0025

(57) ABSTRACT

E-Z TRAM is a tool used in the collision repair business to help restore a vehicle's A, B, C and D Pillars back to its pre-accident condition. E-Z TRAM does this by making comparisons at any points from the undamaged side to the same points on the damaged side of vehicle, by using a special clamp and one non-stretch steel cable, that can be marked at multiple points with tape and a ink mark to check multiple points. Since one end of the cable is attached to the special E-Z TRAM clamp, there is no need for another technician to help hold that end. Also the clamp and cable can be left in place during live pulling until all points match up to the marks on the cable. E-Z TRAM can also be used in conjunction with a regular tape measure and a traditional “auto body tram gauge” by holding on end of each of these tools in position.

E-Z TRAM is a tool used in the collision repair business to help restore a vehicle's A, B, C and D Pillars back to its factory dimensions. The E-Z TRAM does this by making comparisons at any points from the undamaged side to the same points on the damaged side of vehicle, by using a set of two clamps and one cable. E-Z TRAM also helps check factory dimensions in the door and window openings by placing the E-Z TRAM clamp over specific points listed in the factory dimension guides, then taking a measurement with a regular tape measure to other corresponding points in the dimension guides. E-Z TRAM clamps also make it easy for one person to use a traditional “auto body tram gauge” to check the factory dimensions by holding one pointer directly over one of the points being measured by using one of the E-Z TRAM Clamps. Plus the E-Z TRAM can be used on the front windshield and back window openings and Rocker Panels.

### BACKGROUND OF INVENTION

My invention of the E-Z TRAM comes from 38 years experience in the collision repair industry. One of the hardest areas to repair on a vehicle is one that has been hit in the side where the doors hinge, known as the A and B Pillars. In the past the best way to assure the A and B pillars were repaired correctly, so that all the gaps are right and the weatherstrips seal correctly, was to test fit the doors (which usually takes 2 people) during the repair process, sometimes several times if the A and B pillars were not pulled out quite right the first time. Since almost all cars are built symmetrical, which means the left side dimensions are identical to the right side dimensions and if you take any cross measurements, for example; from point A on the left side to point B on the right side, then measure the same point A on the right side to the same point B on the left side of an undamaged vehicle in an X form, you will get the exact same measurement. E-Z TRAM is a tool/system I developed based on vehicles being symmetrical, the system has two clamps (FIG. 1) and a cable (FIG. 2) that are used to make cross comparisons from the undamaged side to the damaged side. My system also makes using a tape measure and a traditional auto body “tram gauge” easier to use when taking measurements. Over the years, I have been testing my system in real life repairs and over those years I have rarely had to test fit doors anymore.

I do this by getting the damaged A, B, C or D pillars to match the undamaged A, B, C or D pillars, by doing cross comparisons using my clamp and cable system I call E-Z TRAM. E-Z TRAM has not only helped me with A, B, C and D pillars, but has also helped in the repair of windshield and back glass openings and rocker panels.

There are other products out there on the market for doing cross measurements. One of said products is a traditional “auto body tram gauge” that has been around for a long time. An auto body tram gauge uses a stiff rail with a pointer on each end, usually either one end slides up and down the rail or the whole rail telescopes to different lengths. There is also some newer versions of this concept that uses some sort frequency to send measurements from end pointer to the other pointer to a computer for viewing, very high tech and expensive. The problem with these type of tram gauges is that it takes two people to use them, one on each end to hold the pointer right on the spot you want to measure, this is especially difficult when making long measurements, and trusting that the person helping holds their end pointer in exactly the right spot you are trying to measure. These type of tram gauges also have to be adjusted for every single measurement you make. E-Z TRAM solves these problems since one end is a clamp that mounts directly over any undamaged point that you want to do your comparison from, eliminated the need for another person to hold it and no chance of it moving around off point, like the chance you take when someone is holding a traditional or high tech “auto body tram gauge”. Also no need to adjust the E-Z TRAM for every comparison you want to do, you can do this because your one point is the clamp that stays in place, the cable that attaches to said clamp can be marked with tape and an ink mark to the exact point you are checking, you can have multiple tape/marks on the cable, these will stay on the cable and the cable stay in place during the repair process. The traditional and high tech “auto body tram gauges” would have to be held in place on both ends usually by two people, for each and every point to be measured and each and every time you make a pull on the damage because you don't want to pull to far, that could be a lot of times checking points and needing help with that. The E-Z TRAM clamp (FIG. 1) can help with the traditional and high tech “auto body tram gauge” by using the center hole on the E-Z TRAM clamp (FIG. 1,B) to center one end of the traditional or high tech “auto body tram gauge” eliminating the need for a second person to hold the pointer over the point they are measuring from.

There is also very high tech measuring systems that require the vehicle to be fixed onto a frame machine. These systems usually use lasers and/or some sort of frequency to achieve measurements. These type systems usually require the technician to select certain points to measure. Also to do a lot of the door opening measuring points may require the doors on the undamaged side to be removed to access some of those points to be measured. The E-Z TRAM does not need to be on a frame rack or have any doors on the undamaged side be removed to do any comparisons between the damaged and undamaged sides.

### DESCRIPTION OF SEVERAL VIEWS OF THE DRAWINGS

The following FIG. 1-5 in the drawings section are the parts that make up the E-Z TRAM.

FIG. 1 E-Z TRAM, clamp, 3 dimensional angle view. This is the main part of the E-Z TRAM that all the other parts in FIG. 2-5 attach to, as described in the detailed description.

FIG. 2 E-Z TRAM, cable, with swivel and quick link connector, cable coiled up view.

FIG. 3 E-Z TRAM, slotted set screw for tape measure, top and side view.

FIG. 4 E-Z TRAM, bolt with hole in it for inserting cable, with wing nut, top and side view.

FIG. 5 E-Z TRAM, allen head set screw for tightening clamp to pinch welds, top and side view.

### DETAILED DESCRIPTION OF INVENTION

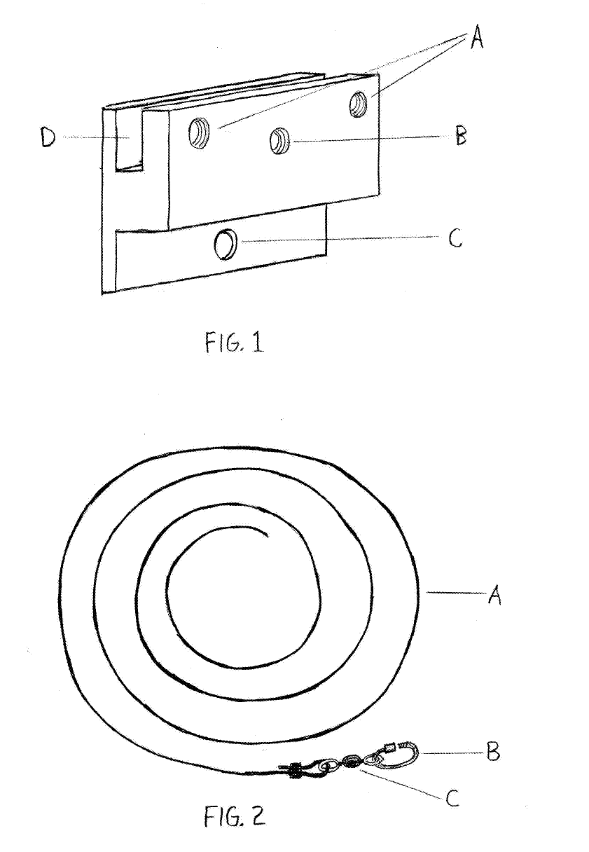

E-Z TRAM is a tool used in the collision repair industry. Unlike a traditional auto body “tram gauge” that uses a stiff rail with a pointer at each end that actually takes measurements. E-Z TRAM does it mostly by comparing points in a X format. E-Z TRAM uses a two clamp, FIG. 1, and flexible steel cable, FIG. 2, system that doesn't actually do any measurements. E-Z TRAM gets its precision from placing both E-Z TRAM clamps, FIG. 1, on the pinch welds at any undamaged points in the door openings at the exact same spot on both sides of the vehicle. Next, all the points wanting to be checked on the damaged side will be marked with masking tape with a line to mark the exact point and a number will be assigned to each mark. Next, the same corresponding points on the undamaged side will be marked with masking tape with a line to mark the same exact corresponding point on the undamaged side and assign the same number as the corresponding point on the damaged side. So now all the numbered points on the damaged side match all the numbered points on the undamaged side. Next, one E-Z TRAM clamp is mounted on each side of the vehicle in exactly the same spot on each side and both clamps need to be in a undamaged area. The E-Z TRAM clamps, FIG. 1, are mounted by inserting the pinch weld into the slot on the E-Z TRAM clamp, FIG. 1,D, and held in place by slightly tightening the allen head grub screws, FIG. 5, into, FIG. 1,A, Next the cable FIG. 2, A, is attached to the clamp FIG. 1,C, on the damaged side, but in a undamaged area of that side of vehicle using the quick link connector FIG. 2, B, the cable is then pulled over to the undamaged side, to points that correspond to the exact same points that you want to check on the damaged side. While pulling the Cable FIG. 2,A, slightly tight over the mark on the masking tape, take a small piece of masking tape and wrap it around the cable and then make a mark on the tape at the exact point the cable crosses over the mark on the tape on the body of the vehicle, then write the corresponding number on the tape on the cable, repeat this step on all points you marked with tape on the undamaged side. Next, you will remove the cable FIG. 2, from the clamp FIG. 1,C, on the damaged side, by undoing the quick link FIG. 2,B, and move the cable FIG. 2, that now has the pieces of tape with marks and numbers on it to the clamp FIG. 1,C, on the undamaged side, by connecting the quick link FIG. 2,B, to the clamp FIG. 1,C, then you slightly pull the cable, FIG. 2, tight over the pieces of corresponding tape with marks and numbers on the damaged side of vehicle, if the marks on the tape on the vehicle line up with the marks on the tape on the cable, FIG. 2, at the corresponding numbers, that part of the vehicle is ok, if they don't line up, you will have do whatever pulling or repairing necessary until all points on the cable, FIG. 2, match up with the corresponding points on the damaged side of vehicle.

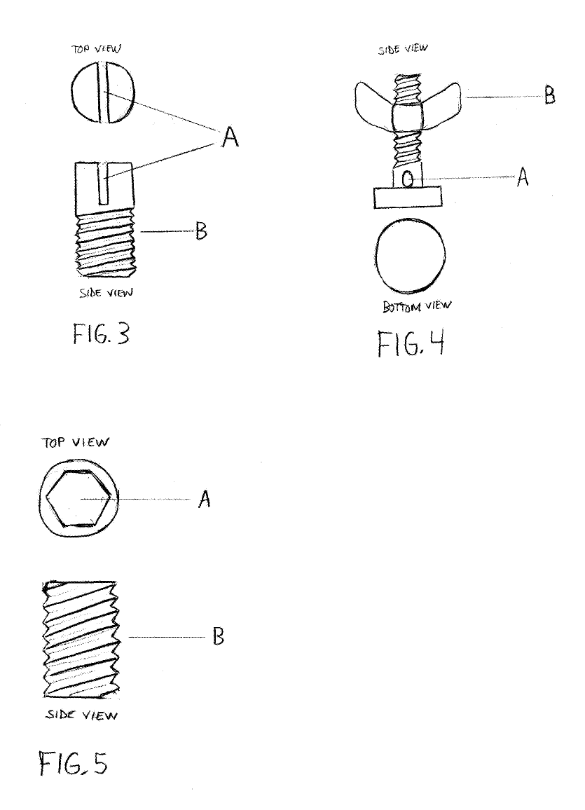

The cable, FIG. 2, will swivel FIG. 2, C, as to make it easier to line up the marks on the cable with the marks on the vehicle itself. The above procedure will confirm that your A, B, C or D pillar is in the correct position as far as being in or out. The E-Z TRAM can also be used to determine if the pillars are in the correct front to back position by using dimensions provided by vehicle manufacturer dimension guides. There is a threaded sight hole on the E-Z TRAM clamp, FIG. 1, B, that allows you to line that hole up with points on the pinch welds in the door openings and slightly tighten the clamp in place (these points are in the dimension guides). Next you partially screw the slotted grub screw FIG. 3, into the threaded sight hole FIG. 1,B. The slot FIG. 3,A, allows a tape measure to be hooked to the slot so you can measure to any of the corresponding points listed in the dimension guides. Since the slotted grub screw, FIG. 3, is loosely threaded into the sight hole FIG. 1,B, it allows the slotted grub screw, FIG. 3, to swivel when the tape measure is moved to different points to be measured. If you do not have access to the dimension guides you can also set up the other E-Z TRAM clamp, FIG. 1, on the undamaged side of vehicle and make comparisons to the damaged side, for example; if the B-pillar is damaged on the right side, you would put one clamp, FIG. 1, on the left side perhaps midway up the A-pillar on the pinch weld and do the same on the right side, then put the cable, FIG. 2,B, on the clamp, FIG. 1,C, on the undamaged side and pull it slightly tight to any point you want to check on the B-pillar and mark it with tape and a mark, next move the cable, FIG. 2, to the clamp, FIG. 1, on the damaged side A pillar and slightly pull it tight to the same point on the damaged side to see if it lines up, if not makes necessary repairs till it lines up. There is one other attachment with the E-Z TRAM used to help in the repair of rocker panels on vehicles. This is done by placing one E-Z TRAM clamp, FIG. 1,D, on each end of the pinch weld on the damaged rocker panel, and slightly tighten into place using the grub screws, FIG. 5. Next, you attach the cable, FIG. 2, to one of the clamps, FIG. 1,C, using the quick link, FIG. 2,B. Then you attach the bolt with the hole in it and wing nut FIG. 4, to the other clamp in hole FIG. 1,C, After that, you put the other end of the cable, FIG. 2,A, through the hole in the bolt FIG. 4, A, and pull the cable slightly tight through the hole, then slightly tighten the wing nut FIG. 4,B, just enough to hold the cable straight. This will show if the rocker panel is straight along the pinch weld, if not, repair as necessary. E-Z TRAM clamps, FIG. 1, can also be used to help when using a traditional auto body “tram gauge” by clamping the E-Z TRAM clamp, FIG. 1, so the threaded sight hole FIG. 1,B, is centered over a point from the dimension guides, to hold one end of the traditional “tram gauge” pointer over that point to make measuring easier. All the above mentioned methods can be applied to repairing other areas of a vehicle, like windshield openings and back glass openings.

1. The E-Z TRAM is an apparatus used in the autobody passenger compartment repair process of any vehicle to make sure a vehicle is restored to its pre-accident symmetrical condition, it accomplishes this by comparing points on the undamaged side to the same exact points on the damaged side, this apparatus is comprised of a clamp (FIG. 1) that attaches firmly to the pinch weld at any undamaged point and a non-stretch steel cable (FIG. 2) the said steel cable attaches to the said clamp (FIG. 1,C) using a quick link (FIG. 2,B) also the said steel cable has a swivel (FIG. 2,C) on the end that the quick link attaches to, as to allow the said cable to swivel for ease of use, the said cable after being attached to the clamp is pulled tight to whatever point that a technician wants to check, then said cable is marked at that point, then that said point can be checked by setting up the apparatus on the exact corresponding point on the opposite side of vehicle, since almost all vehicles today are extremely symmetrical an auto body technician can use this apparatus by himself without any help from another technician to check whatever points necessary in the passenger compartment, to assure that everything is symmetrical, so the body parts in the damaged area fit correctly without having to put the parts on multiple times.

2. The E-Z TRAM clamp (FIG. 1) is an apparatus that attaches to the pinch welds on any vehicle, said apparatus has a hole (FIG. 1,B) in it that is used as a point to center over certain measuring points set forth by the OEM (original equipment manufacturer) of any vehicle, said hole on said apparatus is threaded to accept a threaded fastener (FIG. 3) with a slot in said fastener (FIG. 3,A) for the purpose of hooking a “tape measure” into said slot, for the purpose of taking measurements from that point to other points set forth by the OEM, this eliminates the need to have a second technician to hold one end of the tape measure at said dimension guide point, said “tape measure” is not part of this claim or invention.

3. The E-Z TRAM clamp (FIG. 1) is an apparatus that attaches to the pinch welds on any vehicle, said apparatus has a hole (FIG. 1,B) in it that is used as a point to center over certain measuring points set forth by the OEM (original equipment manufacturer) of any vehicle, this is the same hole as mentioned in (claim 2) said hole is used to center a “traditional tram gauge” pointer over said OEM measuring point as to hold said “traditional tram gauge” pointer in place while extending “traditional tram gauge” to other OEM measurement points, without the need for a second technician to hold that end of the “traditional tram gauge” in place, said “traditional tram gauge” is not part of this claim or invention.
